(19) United States
(12) Patent Application Publication
(10) Pub. No.: US 2017/0337547 A1
(43) Pub. Date: Nov. 23, 2017

(54) SYSTEM AND METHOD FOR WALLET TRANSACTION SCORING USING WALLET CONTENT AND CONNECTION ORIGINATION

(71) Applicant: MasterCard International Incorporated, Purchase, NY (US)

(72) Inventor: Manoneet Kohli, O'Fallon, MO (US)

(21) Appl. No.: 15/158,023

(22) Filed: May 18, 2016

(51) Int. Cl. G06Q 20/36; G06Q 20/40

(52) U.S. Cl. CPC G06Q 20/36; G06Q 20/40

(57) ABSTRACT

A method includes storing a record of an access transaction that involves an access account. The access account is associated with a digital wallet. The method further includes receiving a request for a payment account transaction involving a payment account. The payment account is associated with the digital wallet. The stored record of the access account transaction is referenced. Based at least in part on the referencing of the stored record of the access account transaction, it is determined whether to approve the requested payment account transaction.

### BACKGROUND

FIG. 1 is a block diagram that illustrates a conventional payment system 100. In particular, the representation of the payment system 100 in FIG. 1 reflects the flow of information and messaging for a single payment account transaction.

The transaction in question may originate at a POS (point of sale) device 102 located in a merchant store (which is not separately indicated). A payment card 104 is shown being presented to a reader component 106 associated with the POS device 102. The payment card 104 is often implemented as a physical magnetic stripe card, although alternatively, or in addition, the payment card 104 may include capability for being read by proximity RF (radio frequency) communication with an integrated circuit (IC) chip (not separately shown) that is part of the card, or via a contact interface with the reader component 106. Alternatively, the payment card 104 may encompass a virtual card account number or an electronic wallet, as is known in the art. The primary account number (PAN) for the payment card account represented by the payment card 104 may be stored on the magnetic stripe (not separately shown) and/or the IC chip (if present) for reading by the reader component 106 of the POS device 102.

In some installations, the reader component 106 may be configured to perform either or both of magnetic stripe reading and reading of IC chips by proximity RF communications or by direct electrical contact. Thus, the payment card 104 may be swiped through a mag stripe reading portion (not separately shown) of the reader component 106, or may be tapped on a suitable surface of the reader component 106 to allow for proximity reading of its IC chip, or presented to a contact interface of the reader component 106.

In some transactions, instead of a card-shaped payment device, such as the payment card 104, a suitable conventional payment-enabled mobile phone or a payment fob may be presented to and read by the reader component 106. Also, in some cases, it has been proposed that other payment-enabled devices (e.g. wearable devices such as watches, rings, jewelry of other kinds, wristbands and pendants and so forth) may perform the same role as a fob, payment card, etc. In the case of a payment-enabled mobile phone, the device may run a wallet application (“app”) from which the user may access a so-called digital wallet (stored locally in the device or in a remote server—not shown—to which the wallet app provides access). The digital wallet may encompass an array of payment accounts and possibly other types of accounts belonging to the user.

A computer 108 operated by an acquirer (acquiring financial institution, or “transaction acquirer”) is also shown as part of the payment system 100 in FIG. 1. The acquirer computer 108 may operate to receive an authorization request for the transaction from the POS device 102. The acquirer computer 108 may route the authorization request via a payment network 110 to the server computer 112 operated by the issuer of the payment account that is available for access by the payment card 104. The authorization response generated by the payment account issuer server computer 112 may be routed back to the POS device 102 via the payment network 110 and the acquirer computer 108. Upon receiving a favorable authorization response at the POS device 102, the merchant may complete the transaction and permit the customer/account holder to depart from the store premises with the purchased items.

The authorization request and/or the authorization response are data messages that pass through the payment network 110. The information contained in the messages may include transaction date, day and time, transaction amount, the merchant's name, a category or classification code for the merchant and the merchant location. The payment network may operate to capture and store the quantities of transaction data that represent purchase transactions handled by the payment network

The payment network 110 may be, for example, the well-known Banknet system operated by MasterCard International Incorporated, which is the assignee hereof.

The components of the system 100 as depicted in FIG. 1 are only those that are needed for processing a single transaction. A typical payment system 100 now in use may include a considerable number of payment card issuers and their computers, a considerable number of acquirers and their computers, and numerous merchants and their POS devices and associated reader components. The system may also include a very large number of payment account holders, who carry payment cards and/or other payment-enabled devices.

In addition to the in-store type of transaction illustrated in FIG. 1, payment systems like the system 100 are also frequently used for online shopping transactions and other types of transactions that utilize payment accounts.

In the case of some transactions, the transaction acquirer 108 and/or the account issuer 112 may request that fraud scoring be performed to aid in determining whether to accept or approve the transaction. It has been proposed, for example, that a service affiliated with the operator of the payment network 110 provide a transaction scoring function.

The present inventor has recognized opportunities for utilizing prior transactions involving the user's digital wallet to aid in scoring/approving payment transactions that involve payment accounts included in the user's digital wallet.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram of a payment system according to some embodiments.

FIGS. 3 and 4 are block diagram representations of computers that may serve as components of the system shown in FIG. 2.

FIG. 5 is a block diagram representation of a typical mobile device that may play a role in the payment system of FIG. 2.

FIGS. 6 and 7 are flow charts that illustrate aspects of the present disclosure.

### DETAILED DESCRIPTION

In general, and for the purpose of introducing concepts of embodiments of the present disclosure, an authentication system for payment transactions may score transactions or suggest acceptance/approval of such transactions based on records of other recent transactions. A current transaction may involve a payment account that is held in a digital wallet with other accounts involved in other recent transactions. The other accounts may include “access accounts” by which the user identifies himself/herself to electronic devices that control access to physical spaces, appliances, “smart cars” or the like. In addition or alternatively, the other recent transactions may be payment account transactions that indicate the identity of the person making the transaction, apart from the identity indicated by the payment account involved. All of these types of other recent transactions may tend to indicate that the authorized user remains in control of the digital wallet in question. This in turn may lead to an inference that the current payment account transaction is not fraudulent. Accordingly, reference to the other recent transactions may result in streamlining of authentication/approval for the current transaction.

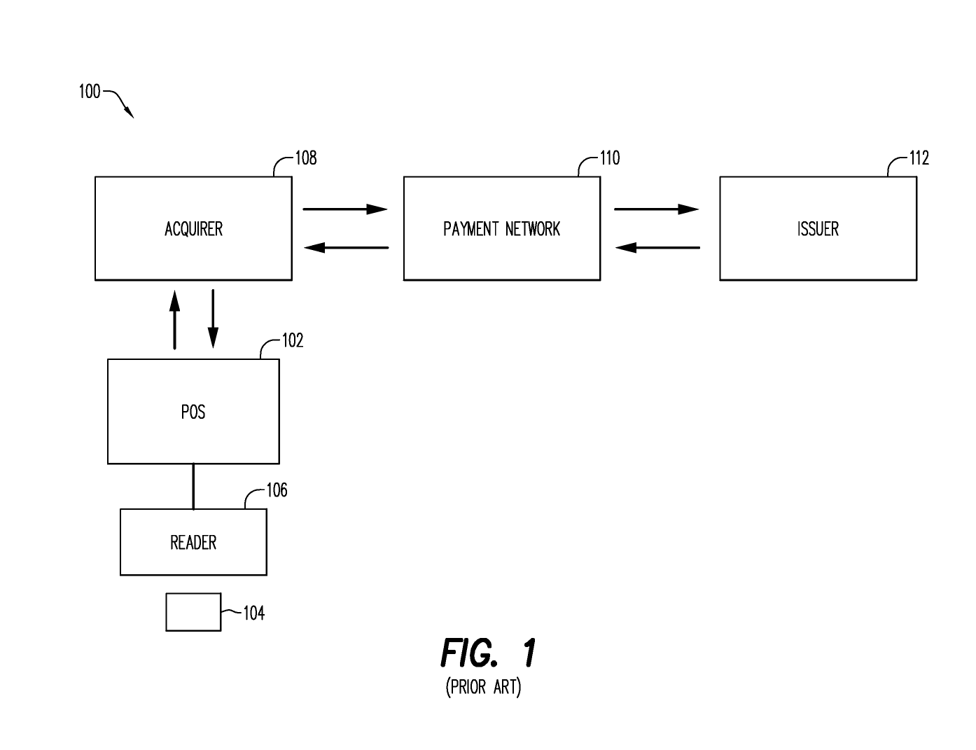

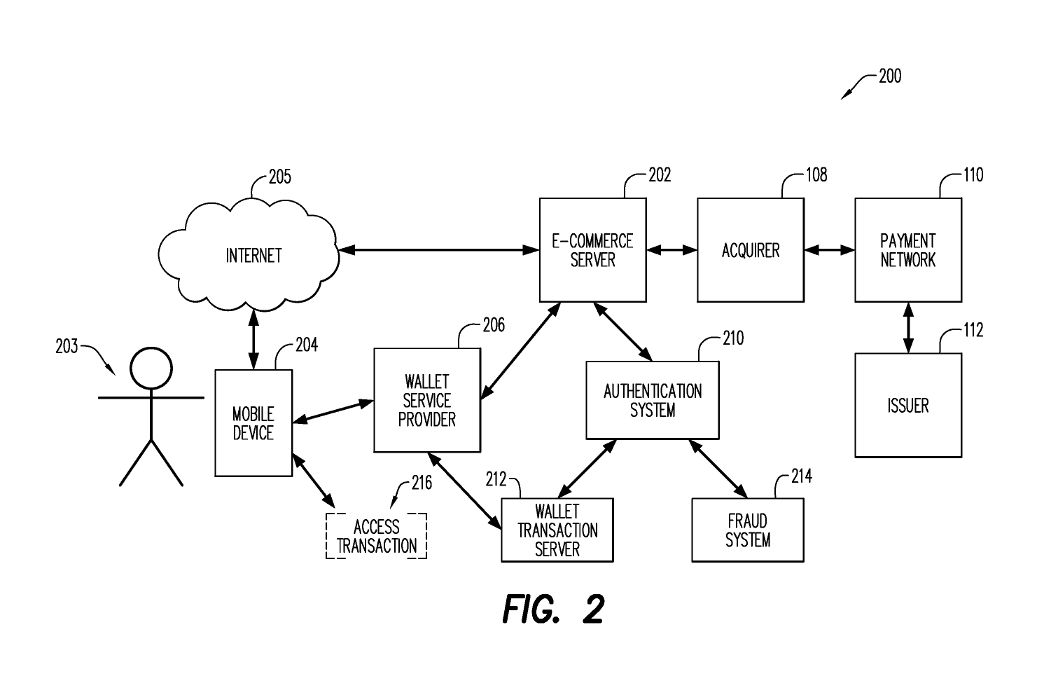

FIG. 2 is a block diagram of a payment system 200 provided according to some embodiments. FIG. 2 primarily depicts the payment system 200 in relation to handling of a single online shopping transaction. The elements 108, 110 and 112 described above in connection with FIG. 1 are also shown in FIG. 2 as components of the payment system 200. The payment system 200 also includes an e-commerce server 202 that may be operated by or on behalf of an online merchant to permit online shopping transactions. (The e-commerce server 202 may be considered, in some ways, to play an analogous role in the payment system 200 to the POS device 102/reader component 106 described above in connection with FIG. 1.) To allow for online shopping transactions, the e-commerce server 202 may host a shopping website, sometimes referred to as an “online store.” A customer 203 who operates a mobile device 204 may access the shopping website by communicating over the internet 205 with the e-commerce server 202. The e-commerce server 202 may provide functionality commonly associated with servers that host online shopping sites, and in some embodiments may provide functionality to conform with teachings of this disclosure. For example, in addition to capturing and forwarding a payment account number or payment token that points to the payment account selected for the current transaction by the customer 203, the e-commerce server 202 may also capture and forward an identifier for a digital wallet accessed to select the payment account.

A wallet service provider (WSP) 206 may be included in the payment system 200. Via interactions between the WSP 206 and either or both of the user's mobile device 204 and the e-commerce server 202, the WSP 206 may permit the user 203 to access the user's digital wallet (not separately shown) maintained in the WSP 206.

According to aspects of the present disclosure, the payment system 200 also includes an authentication system 210. Details of the authentication system 210 will be discussed below. To briefly summarize some of the functionality of the authentication system 210, it may provide guidance to the e-commerce server 202 (and/or to the account issuer 112) as to the degree of risk associated with the payment account transaction illustrated in FIG. 2 In some embodiments, the authentication system 210 may be operated by the operator of the payment network 110.

The payment system 200 may further include a wallet transaction server 212. The wallet transaction server 212 may perform the role of repository for records of transactions engaged in using accounts (including access accounts and/or payment accounts) held in digital wallets maintained in the WSP 206.

Still further, the payment system 200 may include a fraud system 214. The fraud system 214 may be implemented, e.g., as a service provided by the operator of the payment network 110 to aid in preventing or deterring fraudulent payment account transactions.

It should be further understood that aspects of the present disclosure are premised on the notion that—at least possibly—the payment account transaction illustrated in FIG. 2 may have been recently preceded by an access transaction (reference numeral 216) that was performed by the user 203. It may be further assumed that the access transaction was for the purpose of allowing the user 203 to access a physical asset (not shown) such as an appliance or a “smart car” or to gain access to a physical location (not shown) such as a laundry room, exercise room, swimming pool, etc. In addition, the access transaction may have involved the user 203 interacting with the mobile device 204 to present credentials to a gate-keeping device or component or the like (not separately shown), where the credentials are embodied as an access/user identification included with the user's digital wallet.

To discuss the subject matter of FIG. 2 more generally, it should be understood that in most cases, blocks labeled therein with names/descriptions of entities should also be understood to represent computer systems operated by or for such entities.

It should also be understood that, for at least some types of participants in the payment system 200, there may be a considerable or even a very large number of participants of those types in practical embodiments of the payment system 200. Moreover, one or more components of the payment system 200 may handle in-store purchase transactions and/or other types of transactions in addition to online purchase transactions. It should be noted for example, that there may be more than one WSP included in the payment system 200, while the wallet transaction server 212 may operate as a central repository for transactions originating from respective populations of digital wallets maintained by multiple WSPs.

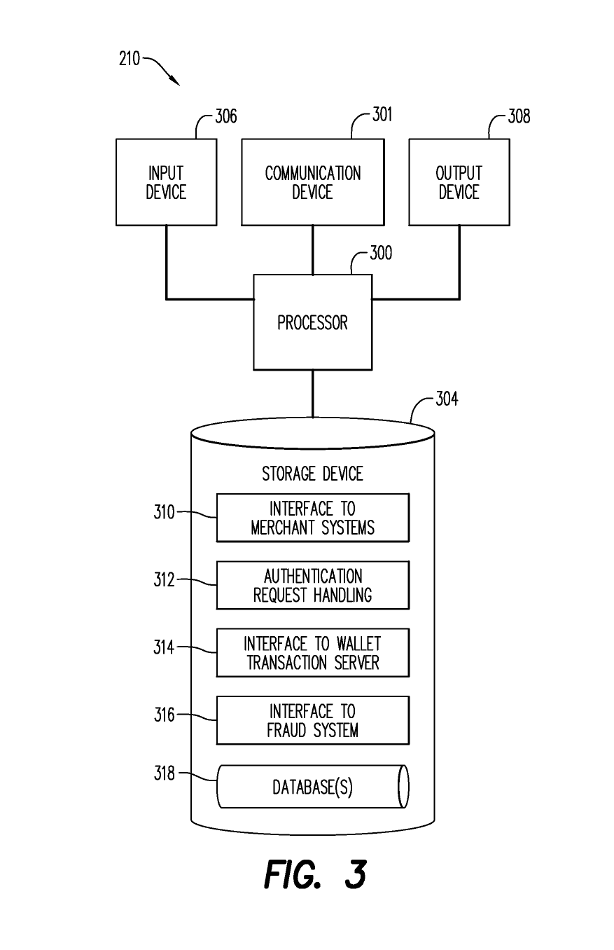

FIG. 3 is a block diagram representation of an embodiment of the authentication system 210.

In some embodiments, hardware aspects of the authentication system 210 may be constituted by typical server computer hardware, but may be controlled by software to cause it to function as described herein.

The authentication system 210 may include a processor 300 operatively coupled to a communication device 301, a storage device 304, an input device 306 and an output device 308. The communication device 301, the storage device 304, the input device 306 and the output device 308 may all be in communication with the processor 300.

The processor 300 may be constituted by one or more processors. The processor 300 may operate to execute processor-executable steps, contained in program instructions described below, so as to control the authentication system 210 to provide desired functionality.

Communication device 301 may be used to facilitate communication with, for example, other devices (such as e-commerce servers, and the wallet transaction server 212). For example, communication device 301 may comprise numerous communication ports (not separately shown), to allow the authentication system 210 to perform its roles in connection with numerous simultaneous online purchase transactions and/or other transactions.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the authentication system 210, executed by the processor 300 to cause the authentication system 210 to function as described herein.

The programs may include one or more conventional operating systems (not shown) that control the processor 300 so as to manage and coordinate activities and sharing of resources in the authentication system 210, and to serve as a host for application programs (described below) that run on the authentication system 210.

The programs stored in the storage device 304 may also include a software interface 310 that controls the processor 300 to support communication between the authentication system 210 and merchant e-commerce servers such as the computer represented by block 202 in FIG. 2.

Further, the storage device 304 may store an authentication request handling application program 312. The authentication request handling application program 312 may control the processor 300 such that the authentication system 210 provides functionality as described herein in connection with requests for guidance related to risk associated with online purchase transactions and/or other transactions.

Still further, the storage device 304 may store a software interface 314 that controls the processor 300 to support interactions between the authentication system 210 and the wallet transaction server 212. In addition, the storage device 304 may store a software interface 316 that controls the processor 300 to support access of the authentication system 210 to the fraud system 214.

The storage device 304 may also store, and the authentication system 210 may also execute, other programs, which are not shown. For example, such programs may include a reporting application, which may respond to requests from system administrators for reports on the activities performed by the authentication system 210. The other programs may also include, e.g., device drivers, database management programs, communications software, etc.

The storage device 304 may also store one or more databases (reference numeral 318) required for operation of the authentication system 210.

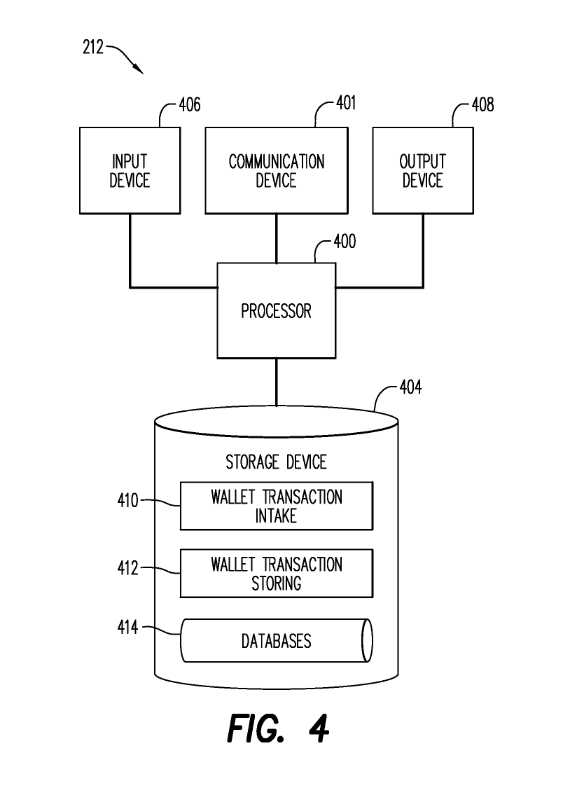

FIG. 4 is a block diagram of an embodiment of the wallet transaction server 212.

In its hardware architecture and components, the wallet transaction server 212 may, for example, resemble the hardware architecture and components described above in connection with FIG. 3. However, the wallet transaction server 212 may be programmed differently from the authentication system 210 so as to provide different functionality.

Returning again to the hardware aspects of the wallet transaction server 212, it may include a processor 400, a communication device 401, a storage device 404, an input device 406 and an output device 408. The communication device 401, the storage device 404, the input device 406 and the output device 408 may all be in communication with the processor 400.

The above descriptions of the hardware components shown in FIG. 3 may, in some embodiments, also be applicable to the like-named components shown in FIG. 4.

Storage device 404 stores one or more programs for controlling processor 400. The programs comprise program instructions (which may be referred to as computer readable program code means) that contain processor-executable process steps of the wallet transaction server 212, executed by the processor 400 to cause the wallet transaction server 212 to function as described herein.

The programs may include one or more conventional operating systems (not shown) that control the processor 400 so as to manage and coordinate activities and sharing of resources in the wallet transaction server 212, and to serve as a host for application programs (described below) that run on the wallet transaction server 212.

The programs stored in the storage device 404 may include a program 410 that controls the processor 400 to permit the wallet transaction server 212 to receive records of transactions performed using access accounts and/or payment accounts included within digital wallets maintained by the WSP 206. The records of transactions may be received by the wallet transaction server 212 from one or more of a number of different sources or types of sources, such as WSPs, merchants (including online merchants), payment networks and/or wallet apps running on users' mobile devices.

Further, the storage device 404 may store a program 412 that handles operations to store and maintain—in a transaction database 414—the transaction records received by the records receiving program 410. It will be noted that the transaction database 414 may also be stored in the storage device 404.

The storage device 404 may also store, and the wallet transaction server 212 may also execute, other programs, which are not shown. For example, such programs may include a reporting application, which may respond to requests from system administrators for reports on the activities performed by the wallet transaction server 212. The other programs may also include, e.g., device drivers, database management programs, communication software, etc.

The storage device 404 may also store other databases (not separately shown) in addition to transaction database 414.

Other computer components of the payment system 200 (FIG. 2) may also have the same type of hardware architecture and/or components as described above in connection with FIG. 3, and may be suitably programmed for the respective roles of those computer components.

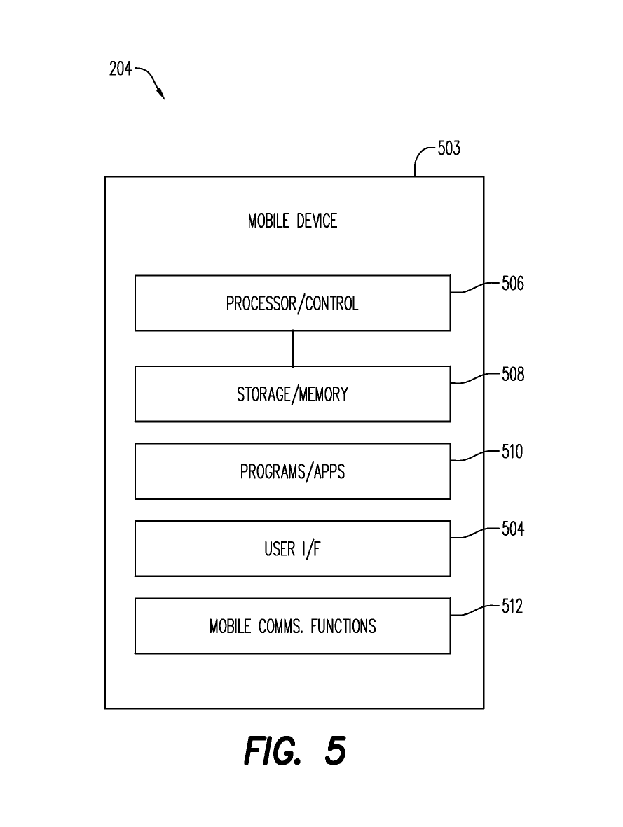

FIG. 5 is a block diagram of a typical embodiment of the mobile device 204 shown in FIG. 2. For purposes of the ensuing discussion, it is assumed (though this assumption should not be taken to be limiting) that the mobile device 204 is embodied as a smartphone.

Continuing to refer to FIG. 5, the mobile device 204 may include a housing 503. In many embodiments, the front of the housing 503 is predominantly constituted by a touchscreen (not separately shown), which is a key element of the user interface 504 of the mobile device 204.

The mobile device 204 further includes a mobile processor/control circuit 506, which is contained within the housing 503. Also included in the mobile device 204 is a storage/memory device or devices (reference numeral 508). The storage/memory devices 508 are in communication with the processor/control circuit 506 and may contain program instructions to control the processor/control circuit 506 to manage and perform various functions of the mobile device 204. As is well-known, a device such as mobile device 204 may function as what is in effect a pocket-sized personal computer (assuming for example that the mobile device is a smartphone), via programming with a number of application programs, or “apps”, as well as a mobile operating system (OS). (The apps are represented at block 510 in FIG. 5, and may, along with other programs, in practice be stored in block 508, to program the processor/control circuit 506.) As suggested by previous discussion, the apps 510 may include a wallet app, by which the user 203 may access his/her digital wallet maintained in the WSP 206 via interaction with the mobile device 204. In addition or alternatively, a wallet app running on the mobile device 204 may provide access to a digital wallet maintained locally, i.e., in the mobile device 204.

As is typical for mobile devices, the mobile device 204 may include mobile and/or other communication functions as represented by block 512. The communication functions 512 may include voice and data communication via a mobile communication network (not shown) with which the mobile device 204 is registered. It should also be understood that the communication capabilities included in the communication functions 512 may also include relatively short-range communication capabilities such as communication in accordance with the well-known WiFi standard. It will be appreciated that a suitable antenna and transceiver arrangement (both not separately shown) may be included in the mobile device 204 to support WiFi communication.

Although also not separately shown in FIG. 5, it should be understood that the communication functions 512 may include hardware aspects such as a microphone, a speaker, an antenna, a transceiver circuit, etc., all supported in and/or on the housing 503, for communication via a mobile communication network.

In some embodiments, the mobile device 204 may also have a communication capability for very short range communication, e.g., in accordance with the NFC communication standard. The hardware and/or software components to provide this functionality are not separately shown. With this capability, the mobile device 204 may—via a suitable wallet app (as referred to above) and/or one or more payment apps—be payment-enabled, as described above in connection with FIG. 1. In addition, the mobile device 204 may run one or more access apps, to permit the mobile device 204 to serve as an “electronic key”. As such, the mobile device 204 may engage in short-range communications to identify the user to various “gate-keeper”devices to allow the user to gain access to one or more physical assets and/or locations, as referred to above.

From the foregoing discussion, it will be appreciated that the blocks depicted in FIG. 5 as components of the mobile device 204 may in effect overlap with each other, and/or there may be functional connections among the blocks which are not explicitly shown in the drawing. It may also be assumed that, like a typical smartphone, the mobile device 204 may include a rechargeable battery (not shown) that is contained within the housing 503 and that provides electrical power to the active components of the mobile device 204.

It has been posited that the mobile device 204 may be embodied as a smartphone, but this assumption is not intended to be limiting, as mobile device 204 may alternatively, in at least some cases, be constituted by a tablet computer.

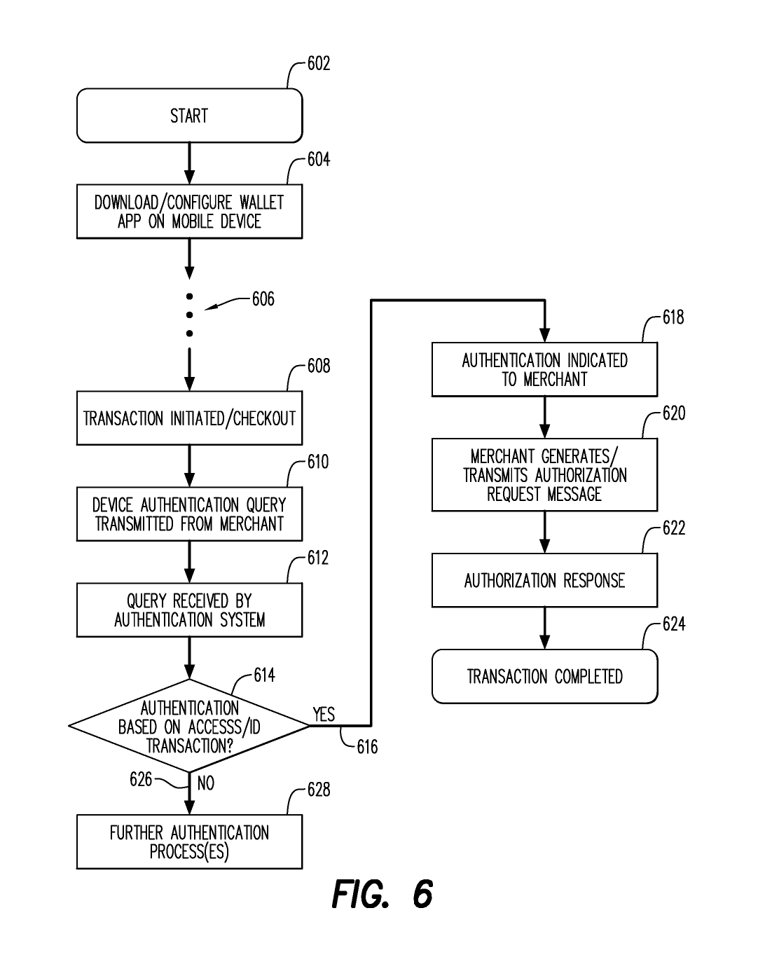

FIG. 6 is a flow chart that illustrates aspects of the present disclosure. The process illustrated in FIG. 6 may be performed in the payment system 200 of FIG. 2.

Block 602 in FIG. 6 represents the start of the process of FIG. 6. Block 604 represents a process stage in which the above-mentioned wallet app is downloaded to, and configured to operate on, the mobile device 204. It may also be assumed that a number of payment accounts and/or access accounts are stored in the user's digital wallet, which may be accessible via the wallet app. It may further be assumed that the user 203 regularly uses the mobile device 204 to perform payment transactions and/or access transactions. Moreover, it may be assumed that the payment and/or access transactions originate via interaction with the user's digital wallet, and the records of such transactions are stored in the wallet transaction server 212.

The balance of the process of FIG. 6, as illustrated after an ellipsis 606, is concerned with handling of a particular payment transaction. It is further assumed that the transaction in question is an online shopping transaction, in which the user 203 employs the mobile device 204 to interact with the shopping website hosted by the e-commerce server 202.

Block 608 represents the initiation of the online shopping transaction, and the user's entry into the checkout phase of the transaction, including selection via the user's digital wallet of a payment account to be used for the transaction.

At block 610, the e-commerce server 202 may transmit a query to the authentication system 210, to request that the authentication system 210 provide guidance as to the degree of risk associated with the current transaction. The query may include information about the transaction, including the account number or payment token that identifies the user's selected payment account. The query may also identify the user's digital wallet from which the payment account was selected.

Block 612 in FIG. 6 represents the authentication system 210 receiving the query transmitted by the e-commerce server 202 at block 610.

Decision block 614 may follow block 612 in the process of FIG. 6. At decision block 614, the authentication system 210 may proceed with a risk assessment for the current transaction based at least in part on whether or not there are other recent and relevant transactions originating from the same digital wallet identified in the query received at 612.

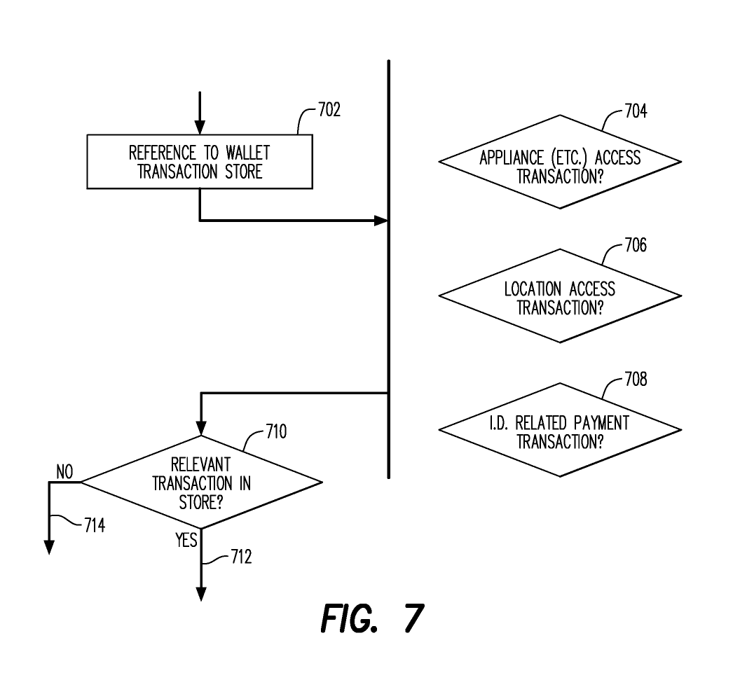

FIG. 7 may be considered to be a decomposition or more detailed illustration of processing performed in connection with decision block 614 of FIG. 6. FIG. 7 thus represents aspects of the present disclosure, and will be seen to also take the form of a flow chart.

Referring now to FIG. 7, at block 702, the authentication system 210 makes reference to the wallet transaction server 212 and the transaction data stored therein. More specifically, the authentication system 210 makes reference to records of transactions that have been stored in the wallet transaction server 212 and that relate to transactions that originated from the digital wallet identified in the query received at 612. All potentially relevant transactions may, for example, be indexed in the wallet transaction server 212 by the identifier for the digital wallet identified in the query received at 612.

Decision blocks 704, 706, 708 represent respective categories of potentially relevant transactions that may be found by the authentication system 210 in its reference to records stored in the wallet transaction server 212. Decision block 704 represents access transactions related to obtaining access to physical assets such as appliances (e.g., refrigerators, clothes-washing machines, clothes-drying machines, dishwashers, etc.) or other types of machines such as motor vehicles (e.g., so-called “smart cars” to which access is obtained via an access app that identifies the user/holder of the app in question).

Decision block 706 represents access transactions related to obtaining access to physical locations or spaces, such as a laundry room, an exercise room, a gated community, a building, an apartment, an office suite, etc. Again, access apps that run on the mobile device 204 and that identify the user 203 may be employed to obtain access via these transactions.

Decision block 708 represents payment account transactions that relate to particular types of payments that are in some way keyed to the identity of the payment account holder. These may include payment of taxes, government fines, rent, mortgage installments, etc. All of such payment transactions are unlikely to be performed using a payment-enabled mobile device that has been misappropriated because they would only benefit someone who can be readily identified from the nature of the payment.

Other types of transactions that may be considered relevant may be transactions in which the user's identity is confirmed, e.g., via a passport account, a driver's license account, etc.

Decision block 710 in FIG. 7 represents a determination as to whether a record of a relevant transaction has been found in the transaction data store referenced at 702. A transaction may be deemed relevant if it is of one of the types described in connection with this FIG. 7 and if it has occurred within a relatively short pre-determined period of time up to the time of receiving the query at 612 (FIG. 6). For example, in some embodiments, the pre-determined period may be 4 hours, 2 hours or 1 hour. If a transaction of one of these kinds has occurred within such a short time frame before the current payment transaction, and originating from the same digital wallet as the current payment transaction, it may be reasonable to infer that the user's mobile device 203 has not been stolen and that the current payment account transaction is likely to be a legitimate transaction.

In some embodiments, when a location-related access control transaction is used to assess risk and/or to perform risk scoring with respect to the current payment account transaction, the authentication system 210 may also consider/confirm that the access account transaction occurred within a particular relevant time threshold shortly before the current payment account transaction. In addition or alternatively, the authentication system may receive and consider location data (e.g., so-called “geo-ip” data) concerning the mobile device at the time of the access account transaction to confirm that the location of the mobile device conforms to the location accessed in the access account transaction.

In some embodiments, in addition to referencing recent transactions from the relevant digital wallet, the authentication system 210 may seek and receive input from the fraud system 214 as to the degree of risk associated with the current transaction. The input from the fraud system 214 may be based on transaction data for the current transaction provided from the authentication system 210 to the fraud system 214.

If a relevant transaction is found in the processing of FIG. 7, then branch 712 may be followed from decision block 710. Branch 712 in FIG. 7 corresponds to branch 616 (from decision block 614) in FIG. 6. Referring once more to FIG. 6, branch 616 leads on to block 618 in FIG. 6. At block 618, the authentication system 210 may provide a suitable code to the e-commerce server 202 to indicate authentication of the transaction and/or the holder of the payment account selected for the current transaction. Then, at block 620 in FIG. 6, the e-commerce server 202 may generate a more or less conventional transaction authorization request message to be routed to the account issuer 112 via the transaction acquirer 108 and the payment network 110. At block 622, the merchant/e-commerce server 202 may receive an authorization response (i.e., reflecting the account issuer's determination as to whether all is in order with the user's payment account selected for the current transaction). Block 624 represents completion of the online shopping transaction.

Referring again to FIG. 7, if no relevant transaction is found in the processing of FIG. 7, then branch 714 may be followed from decision block 710. Branch 714 in FIG. 7 corresponds to branch 626 (from decision block 614) in FIG. 6. Referring yet again to FIG. 6, branch 626 leads on to block 628 in FIG. 6. At block 628, the authentication system 210 may proceed with one or more further authentication processes. For example, the authentication system may perform a user authentication process of a kind in which a password-entry challenge or biometric challenge may be issued to the user 203 from the authentication system 210 via the mobile device 204.

By basing risk scoring/transaction authentication processing on location-based, physical-asset based or identification-connected recent transactions from a common digital wallet, it may be possible to streamline approval/acceptance of a payment account transaction, while achieving an improved trade-off between transaction security and user convenience.

In examples described up to this point, the query to the authentication system is made by an online merchant. In addition or alternatively, such queries may come to the authentication system from a retail store location and/or from a payment account issuer.

As used herein and in the appended claims, the term “approving a transaction” refers to either or both of a merchant accepting a proposed transaction for submission to an account issuer, or an account issuer's indication of approval in a transaction authorization response message.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
storing a record of an access account transaction that involves an access account, said access account associated with a digital wallet;
receiving a request for a payment account transaction involving a payment account, the payment account associated with said digital wallet;
referencing said stored record of the access account transaction; and
determining whether to approve the requested payment account transaction based at least in part on a result of said referencing step.

2. The method of claim 1, wherein said access account transaction involved obtaining access to a physical asset or location.

3. The method of claim 2, wherein said access account transaction involved obtaining access to an appliance or a vehicle.

4. The method of claim 2, wherein the access account transaction involved obtaining access to a location;
the determining step including:
determining that the access account transaction occurred within a pre-determined time period prior to receiving said request; and
receiving location data concerning a location of a user device used in the access control transaction, to confirm that the location of the user device conforms to the location accessed in the access account transaction.

5. The method of claim 1, wherein the access account is an identification account that identifies an owner of the digital wallet, said identification account not being a payment account.

6. The method of claim 5, wherein said identification account provides travel privileges.

7. The method of claim 5, wherein said identification account is a driver's license.

8. The method of claim 1, wherein said referencing step includes determining whether said access account transaction occurred within a pre-determined period of time prior to receiving said request.

9. The method of claim 8, wherein said pre-determined period is no more than 4 hours.

10. The method of claim 1, wherein the payment account transaction is an online shopping transaction.

11. A method comprising:
storing a record of a first payment account transaction, said first payment account transaction for (a) making a rent payment; (b) making a mortgage payment; (c) making a tax payment; (d) paying a utility bill; or (e) paying a government fine; the first payment transaction involving a payment account;
receiving a request for a second payment account transaction, said request involving said payment account;
referencing said stored record of the first payment account transaction; and
determining whether to approve the requested second payment account transaction based at least in part on a result of said referencing step.

12. The method of claim 11, wherein said referencing step includes determining whether said first payment account transaction occurred within a pre-determined period of time prior to receiving said request.

13. The method of claim 12, wherein said pre-determined period is no more than 4 hours.

14. An apparatus comprising:
a processor; and
a memory in communication with the processor, the memory storing program instructions, the processor operative with the program instructions to perform functions as follows:
storing a record of an access account transaction that involves an access account, said access account associated with a digital wallet;
receiving a request for a payment account transaction involving a payment account, the payment account associated with said digital wallet;
referencing said stored record of the access account transaction; and
determining whether to approve the requested payment account transaction based at least in part on a result of said referencing step.

15. The apparatus of claim 14, wherein said access account transaction involved obtaining access to a physical asset or location.

16. The apparatus of claim 15, wherein said access account transaction involved obtaining access to an appliance or a vehicle.

17. The apparatus of claim 14, wherein the access account is an identification account that identifies an owner of the digital wallet, said identification account not being a payment account.

18. The apparatus of claim 17, wherein said identification account provides travel privileges.

19. The apparatus of claim 17, wherein said identification account is a driver's license.

20. The apparatus of claim 14, wherein said referencing step includes determining whether said access account transaction occurred within a pre-determined period of time prior to receiving said request.

21. The apparatus of claim 20, wherein said pre-determined period is no more than 4 hours.
